(19) United States
(12) Patent Application Publication
(10) Pub. No.: US 2001/0023429 A1
(43) Pub. Date: Sep. 20, 2001

(54) DATA BROADCASTING SYSTEM AND METHOD FOR DISTRIBUTING DATA FROM ONE OR MORE CONTENT PROVIDERS TO PERSONAL COMPUTERS

(76) Inventors: KEITH R. BARKER, BELMONT, CA (US); MARK T. RAFTER, LOS GATOS, CA (US)

Correspondence Address: JOYCE KOSINSKI, PATENT ADMINISTRATOR, LORAL SPACE AND COMMUNICATIONS, 655 DEEP VALLEY DRIVE SUITE 303, ROLLING HILLS ESTATES, CA, 90274

(21) Appl. No.: 09/249,890

(22) Filed: Feb. 16, 1999

(51) Int. Cl. G06F 15/16; G06F 9/455

(52) U.S. Cl. 709/203

(57) ABSTRACT

Improved data broadcasting systems 10 and methods 60 that distribute data to personal computers 16. The architecture of the data broadcasting system includes a content acquisition management system 20 having a publishing element 25, a broadcasting element 26, and a subscribing element 27. The publishing element packages data and data processing instructions for broadcast. The broadcasting element broadcasts the packaged data and data processing instructions. The subscribing element receives the packaged data from the broadcasting element and processes the data in accordance with the data processing instructions contained in the received data. An exemplary data distribution method comprises the following steps. Data and data processing instructions are packaged 61 for broadcast. The packaged data and data processing instructions are broadcast 62. The packaged data and data processing instructions are received 63 at remotely located personal computers. The received data are processed 64 at the remotely located personal computers in accordance with the data processing instructions.

### BACKGROUND

The present invention relates generally to data distribution systems and methods, and more particularly, to improved data distribution systems and methods that use Internet protocol (IP) services to distribute data to personal computers, and wherein data and data processing instructions are packaged, broadcast, received by personal computers, and the data is processed in accordance with the data processing instructions contained in the received data.

Hughes Network Systems operates a DirecPC™ satellite-based data distribution system that is used to distribute data from a content provider to client personal computers by way of a satellite. Certain details regarding this system are disclosed in U.S. Pat. No. 5,727,065 entitled “Deferred billing, broadcast, electronic document distribution system and method” and U.S. Pat. No. 5,652,795 entitled “Method and apparatus for an adapter card providing conditional access in a communication system”.

However, the DirecPC system does not distribute data using Internet protocol (IP) addressing. Furthermore, the DirecPC system experiences limitations in the rate at which data may be delivered to the client personal computers. This limitation is caused by the relatively low data throughput rate of the transponders used on the satellite.

It would be an improvement to have data distribution systems and methods that use Internet protocol (IP) services to distribute data to personal computers. It would also be an improvement to have data distribution systems and methods that package data along with data processing instructions, broadcast the packaged data and instructions to remotely located computers, and process the data at the remotely located computers in accordance with the data processing instructions contained in the received data.

### SUMMARY OF THE INVENTION

The present invention provides for improved data broadcasting systems and methods that distribute data to personal computers. The architecture of the data broadcasting system comprises a content acquisition management system that includes a publishing element, a broadcasting element, and a subscribing element.

The publishing element packages data and data processing instructions for broadcast. A broadcasting element broadcasts the packaged data and data processing instructions. A subscribing element receives the packaged data from the broadcasting element and processes the data in accordance with the data processing instructions contained in the received data.

In an exemplary embodiment, the present invention provides for a satellite-based data distribution system that dynamically manages data distribution sessions, dynamically controlling the rate and time of delivery of the data and dynamically controlling the bandwidth of the channel that delivers the data to client personal computers. This dynamic control provides for faster transfer of data and the ability to transfer large data files more efficiently that previous systems.

The system implements a secure unicast and multicast data delivery service that provides the delivery of data, which may involve prescheduled, ad-hoc or on demand broadcasts. Reliable data broadcast is provided with improved rain fade mitigation and forward error correction. The system permits high speed Internet browsing, reception of streaming video, audio and data, and private secure network broadcasts using hardware-based conditional access.

The system provides broadband communication to personal computers using Internet protocols and digital video broadcast technologies. The system thus merges distribution of video and data to personal computers using a single service.

An exemplary method that distributes data to remotely located personal computers comprises the following steps. Data and data processing instructions are packaged for broadcast. The packaged data and data processing instructions are broadcast. The packaged data and data processing instructions are received at remotely located personal computers. The received data are processed at the remotely located personal computers in accordance with the data processing instructions.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary data distribution system in accordance with the principles of the present invention for distributing data by way of a satellite to personal computers;

FIG. 2 illustrates the architecture of the content acquisition management system used in the data distribution system of FIG. 1;

FIG. 3 illustrates the layered nature of the software associated with the content acquisition management system of FIG. 2; and

FIG. 4 illustrates an exemplary method in accordance with the principles of the present invention that distributes data to remotely located personal computers.

### DETAILED DESCRIPTION

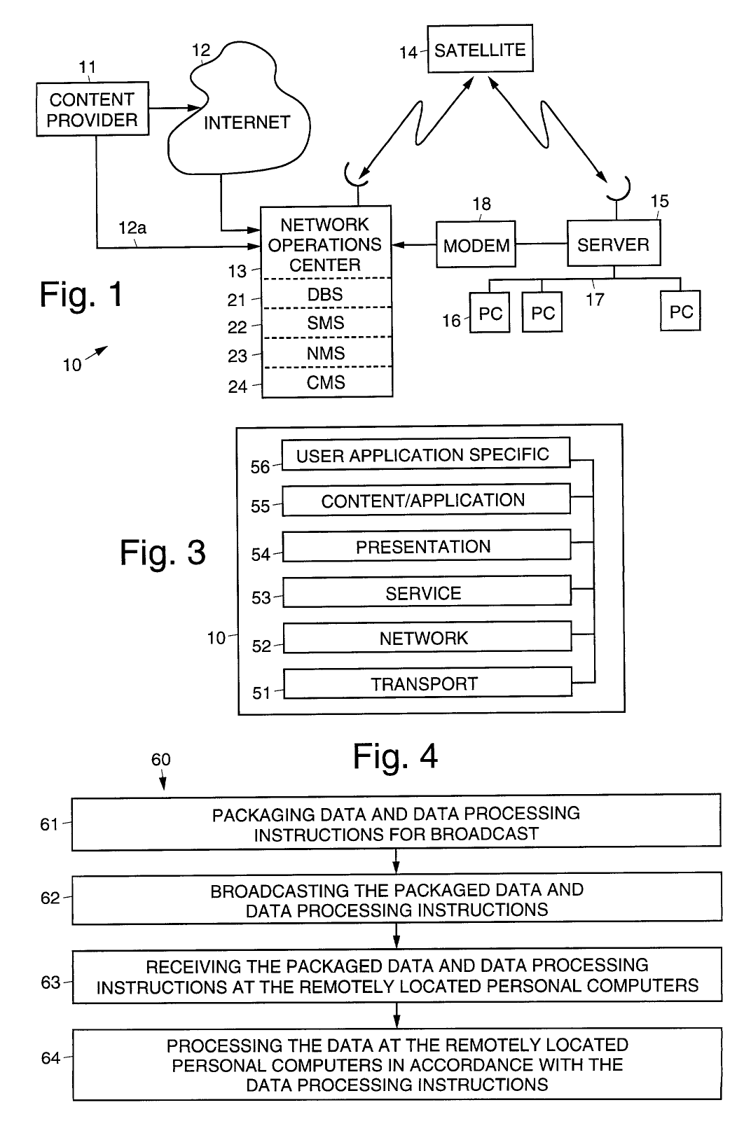

Referring to the drawing figures, FIG. 1 illustrates an exemplary data distribution system 10 in accordance with the principles of the present invention, and is illustrated as a satellite broadcast data distribution system 10. The system 10 is designed to distribute data derived from one or more content providers 11 by way of a satellite 14 to client personal computers (PCs) 16. One aspect of the system 10 is that it uses Internet protocol (IP) addressing to distribute the data to the personal computers 16.

The system 10 comprises a network operations center 13 that includes a data broadcast system (DBS) subsystem 21, a business subsystem (IBS) 22, a subscriber management subsystem (SMS) 23, and a content management subsystem (CMS) 24. One or more content providers 11 communicate by way of a direct line 12a or the Internet 12, for example, to the network operations center 13. The network operations center 13 communicates by way of a satellite 14 to the client personal computers 16.

In typical situations, the client personal computers 16 are coupled to a server computer 15 by way of a local area network 17, or intranet 17. However, it is to be understood that the use of the server computer 15 is not required. A single user standalone, comparably-equipped personal computer 16 may also provide the same functionality as the server computer 15. The server computer 15 (or the comparably-equipped standalone personal computer 16) interfaces to the satellite 14. This is achieved using a satellite receiver PC card, for example, disposed in the personal computer 16 or server computer 15. The personal computer 16 or server 15 is also coupled by way of a modem 18 to the network operations center 13. The modem 18 provides a low-rate return path that is used to transmit requests from the client personal computers 16 to the network operations center 13 in order to download data derived from the content providers 11.

Each of the personal computers 16 includes software 20 comprising a content acquisition management system 20 that interfaces to the network operations center 13 and the content providers 11. The software 20 is used to browse the Internet 12, send requests for data, control data download sessions, schedule delivery of data, and download streaming audio, video and data to the personal computer 16 in real time, for example.

The system 10 and the software 20 cooperate to establish a virtual private multicast network between the content providers 11 and the client personal computer 16. The system 10 and the software 20 cooperate to provide managed electronic data delivery to multiple personal computers 16. The system 10 and the software 20 cooperate to permit remote subscriber site management from the network operations center 13. The software 20 has an open architecture that permits third party application integration. The system 10 and the software 20 cooperate to provide both video and data download services with high efficiency which has heretofore not been provided.

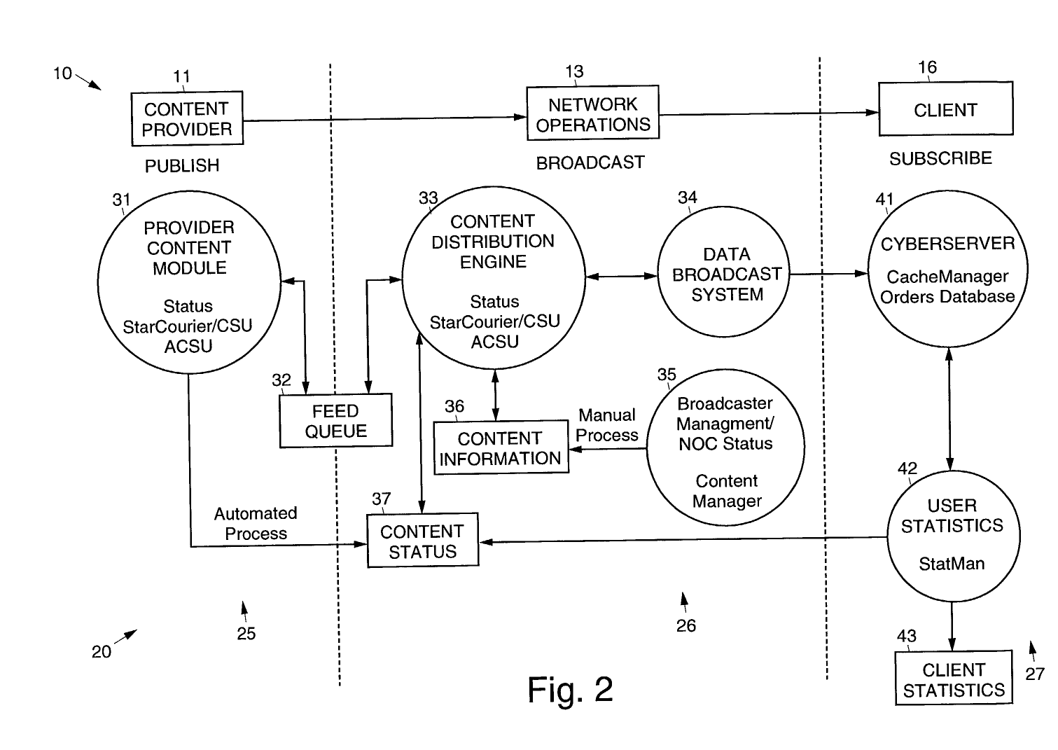

FIG. 2 illustrates the architecture of the content acquisition management system 20 used in the exemplary satellite broadcast data distribution system 10 of FIG. 1. The architecture of the content acquisition management system 20 includes a publishing element 25, a broadcasting element 26, and a subscribing element 27.

The publishing element 25 packages information for broadcast. A package includes any unit of multimedia information that the content acquisition management system 20 can submit for broadcast. In addition, the package contains two elements, including meta content and content. The meta content specifies attributes associated with content (such as type, expiration, product, and the like). The meta content is used by end users or clients operating their personal computers 16 to subscribe, filter, delete, manage, etc., the delivered content. Packages have unique identifiers, and are associated with a product. Content is a collection of one or more assets. The content may be a file or a set of files that are aggregated, and may be compressed or uncompressed.

A product is something that an end user can “subscribe to” or order at an advertised time. Each package that is broadcast is associated with a product. Packages inherit the attributes associated with the product, and can extend the information. Products can be associated with monthly, free to air, and other special billing approaches. Products are also associated with a content provider 11. Products are uniquely identified in the content acquisition management system 20.

Orders are associated with content providers 11 and specific receivers located in the server computer 15 or personal computers 16. The order provides the basis for file confirmation and billing on a per-transaction basis. Orders have additional attributes not available with packages (such as recipients).

A catalog is a set of files containing programming announcements. The catalogs build a set of announcements used by clients in the subscription process. The catalogs define such things as valid products, schedule time frames, and network specific information.

The publishing element 25 includes a provider content software module 31 that typically resides on a server computer at the content provider 11. The software module 31 of the publishing element 25 is configured to allow the content provider to schedule content feeds and ad-hoc feeds (i.e., emergency or unplanned broadcasts). The software module 31 of the publishing element 25 allows the content provider 11 to designate unique content types and implement unique application packaging capabilities. The software module 31 of the publishing element 25 may be configured to submit packaged content to specific clients.

Content may be manually or automatically submitted by the content provider 11 using the software module 31 of the publishing element 25. The software module 31 of the publishing element 25 is configured to allow third party applications to be used to submit or publish data for broadcast by the system 10. Content providers 11 use the software module 31 of the publishing element 25 to submit requests for content usage and proposed content submissions. Content may be submitted in real-time or ahead of time which allows the content to be stored at the network operations center 13 and forwarded to client personal computers 16 at the designated time.

The broadcast element 26 comprises a content distribution software engine 33 that is coupled to a data broadcast system 34. The content distribution engine 33 provides the ability to schedule broadcasts, schedule unplanned broadcasts, and schedule premium/protected broadcasts. The content distribution engine 33 allows broadcast of global/free to air content. The content distribution engine 33 tracks and logs all transactions associated with each broadcast and outputs billing information, along with usage data.

Content status data 37 is derived from the software module 31 of the publishing element 25 and user statistics module 42 in the subscribing element 27. Client statistics 43 are generated by a StatMan software module in the user statistics module 42. A content manager 35 processes content information 36 which is input to the content distribution engine 33 to control broadcasting of content be each respective content provider 11. The content distribution engine 33 enables conditional access by clients and content providers 11. The content distribution engine 33 generates program schedules and relays the information to the data broadcast system 34 which broadcasts announcements of schedule.

The broadcast element 26 provides the ability to store and forward content, which is done using a feed queue 32. The broadcast element 26 establishes network broadcasting standards for the integration of data derived from multiple providers 11 within a singular broadcast.

The subscribing element 27 includes a client software module 41 that allows manual and automatic reception of content by clients and client personal computers 16. The client software module 41 allows a client to subscribe to premium/protected broadcasts. The client software module 41 permits unattended operation. The client software module 41 provides for data management of content on local caches located on client personal computers 16. The client software module 41 provides a reference application that manages content reception at the personal computers 16. The client software module 41 provides a means to integrate third party applications into the system 20.

The client software module 41 receives announcements of program schedules for use in subscribing to receive content. The client software module 41 gathers and outputs usage data relating to subscriptions for billing purposes. The client software module 41 utilizes the announcements to filter and profile the received data. The client software module 41 provides for real time acquisition of content streams based on announcement schedules. The client software module 41 manages data received from multiple content providers 11 within a singular data management scheme.

FIG. 3 illustrates the layered nature of the software associated with the content acquisition management system 20. The content acquisition management system 20 contains six cooperative software layers including a transport layer 51, a network layer 52, a service layer 53, a presentation layer 54, a content/application layer 55 and a user application specific layer 56. Described below are options under each of six levels of a transport service taxonomy. Each level provides a set of characteristics to the specific transport service.

The transport layer 51 provides digital video broadcast transport and broadcast links. The transport layer 51 is implemented using the data broadcast network (DBN) 21 and software from News Digital Systems (NDS). Transport services provided the transport layer 51 apply to data leaving the network operations center 13 and destined for client personal computers 16. This is the most complex service provided by the content acquisition management system 20, having to do with the mechanisms and features associated with broadcasting data from the network operations center 13.

The content acquisition management system 20 provides free-to-air or conditional access (CA) encrypted services. The free-to-air service bypasses the encryption capabilities of the NDS conditional access system and is available for reception by all clients. This service may use data level encryption, depending on the prerogative of the content provider 11 that provides the data, thereby providing some measure of data protection without conditional access.

The encrypted service uses the protection of the NDS conditional access system to prevent unauthorized access to broadcast content. This capability provides a very secure method of transmission and access to data for any combination of subgroups of clients who are entitled to receive the data. The conditional access encrypted service may also use data level encryption as an added measure of protection.

The network interface layer 52 provides virtual Internet protocol unicast and multicast network interfaces. The network interface layer 52 implements subscriber (client) management and conditional access services.

Three types of satellite delivery networks may be implemented for use by clients, including shared networks, common networks, and private networks. These networks define which client sites receive which specific content. This information is used to assign virtual channels (a temporary allocation of bandwidth) within the headend of the data broadcast network 21 for purposes of scheduling content for delivery. Through this operation, it is determined how much content (in megabytes) is sent to how many sites using how much bandwidth (in megahertz) and at what time of the day. This information is also used for billing client accounts.

A shared network is a network in which several clients share a virtual channel. A common network is a shared virtual channel, but shared only by a single client. A private network is a virtual channel dedicated to a subset of a client's user community, and no other users (internal or external to that client) have access to that private network. A single user may participate in several shared, common and private networks.

Scheduling, within the data distribution system 10, refers to the coordination of transponder and conditional access resources (time and bandwidth) for purposes of broadcasting content to clients. Scheduling and delivery parameters associated with content to be delivered are defined. Parameters to be considered include type of scheduling option, requested time(s) of broadcast, duration of broadcast, and data rate of broadcast. These parameters are not applicable to all scheduling options. Four types of scheduling options are provided to clients, including prescheduled, reservation, ad-hoc, and on-demand.

Prescheduled service corresponds to an a priori reservation of bandwidth within the broadcast schedule. Prescheduled service requires a requested time of broadcast, duration of the broadcast, and the requested data rate of the broadcast.

Reservation scheduling is similar to the prescheduled service, except that the client reserves time slots for broadcasting of their content with the ability to cancel that broadcast at a finite time (e.g., 24 hours) prior to the scheduled broadcast time. Reservation scheduling also requires requested time of broadcast, duration of broadcast, and the requested data rate of broadcast.

Ad-hoc scheduling provides clients with the ability to send content to the network operations center 13 and know that it will be broadcast within any suitably agreed to amount of time. Typical service times may be for delivery within two, twelve, and twenty-four hours or on a “best effort” basis. Times are measured from the successful receipt of the client's content at the network operations center 13. Ad-hoc service requires the requested broadcast window.

On-demand scheduling provides the ability for clients to have content broadcast almost immediately after arrival of the content at the network operations center 13. Providing this type of service requires a dedicated virtual channel. On-demand service requires identification of content as on demand scheduled.

The service layer 53 provides content packaging and development services. The service layer 53 includes data packaging tools, application program interfaces (APIs), the content acquisition management system 20 and may include development applications.

The exemplary data distribution system 10 provides three basic satellite-based delivery services; 1) file transfer, 2) high-speed browsing, and 3) streaming. The file transfer delivery service uses point-to-multipoint broadcasting (multicasting) to broadcast packaged content to multiple sites simultaneously. File transfer delivery is offered in two transmission modes including one time broadcast and reliable broadcast. Reliable broadcast uses a configurable number of rebroadcasts to ensure a high likelihood of successful file receipt at the client personal computers 16. A guaranteed file transfer delivery service using receipt acknowledgement may also be provided.

High speed browsing delivery service provides a satellite-based forward channel download capability for standard Internet and World Wide Web access. The service uses a terrestrial return path through the modem 18 and requires that clients use an Internet Services Provider connection in that return path. Service levels are determined by the data rates assigned to the individual client sessions. Two service level categories are available including guaranteed rate and best available rate. Guaranteed rate requires a limit to the number of clients that have access to the guaranteed rate service at any one time. Clients that are denied access to guaranteed rate service are defaulted to the best available service. Data rates for the best available service are determined by the number of clients at any one time and the amount of a priori transponder bandwidth allocated to this service.

Streaming delivery service refers to the broadcast of IP-based data streams or native MPEG II video streams through a virtual channel allocated on the satellite 14. The streamed information may be viewed at the time of broadcast or stored on the client personal computers 16 for later use.

The presentation layer 54 provides content display on the client personal computers 16. The presentation layer 54 is implemented using a customized graphical user interface (GUI), and either Microsoft Internet Explorer™ or Netscape Navigator™ browsing applications.

The content/application layer 55 provides tagging and data management functions. The content/application layer 55 provides XML/HTML tagging and data management applications.

The content/application layer 55 provides content submission, hosting and management services. These services relate to how data is being delivered to, and stored A content submission utility (CSU) is used that allows content providers 11 and clients to submit pre-formatted content to the network operations center 13. The pre-formatting is done by the content submission utility and provides the proper content tags to handle the data in client applications. The content submission utility operates within a standard web browser on the client personal computers 16 or at the content providers site and delivers the content via the Internet 12 or other dedicated connections as defined for a particular client.

Dedicated connections and custom feed handlers may be readily developed for content submission requirements that are beyond the capabilities of the content submission utility. Content submission connections include ISDN, fractional or full T1, trusted T1, ATM or other custom approaches. Feed handler development includes interfacing to a client's existing content submission tools and the integration of these with the content submission utility.

Received content is hosted at an FTP site at the network operations center 13. Also, package delivery receipts may be hosted on a web site at the network operations center 13. The following hosting services may be provided by the system 10 including minimum hosting: with 1 GB reserved FTP space, and a content persistence of 24 hours, or custom hosting per client requirements.

A variety of content management services may be provided. These services include content production, aggregation, and quality assurance testing. These services include content hosting services.

The user application specific layer 56 provides overlays and interfaces for client applications. The user application specific layer 56 is implemented using content channels and third part applications.

For the purposes of completeness, FIG. 4 illustrates an exemplary method 60 in accordance with the principles of the present invention that distributes data to remotely located personal computers 16. Data and data processing instructions are packaged 61 for broadcast. The packaged data and data processing instructions are broadcast 62. The packaged data and data processing instructions are received 63 at the remotely located personal computers 16. The received data are processed 64 at the remotely located personal computers 16 in accordance with the data processing instructions.

Thus, improved data distribution systems and methods have been disclosed that use Internet protocol services to distribute data to personal computers and that packages data and data processing instructions, broadcasts the packaged data and instructions to remotely located computers, which data is processed at the remotely located computers in accordance with the data processing instructions. It is to be understood that the described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A data broadcasting system 10 for distributing data to personal computers, comprising:
a publishing element 25 for packaging data and data processing instructions for broadcast;
a broadcasting element 26 for receiving and broadcasting the packaged data and data processing instructions; and
a subscribing element 27 for receiving the packaged data processing instructions from the data broadcasting element and for processing the data in accordance with the data processing instructions.

2. The system 10 recited in claim 1 wherein the publishing element comprises a provider content software module 31 that allows a content provider to schedule content feeds and ad-hoc feeds.

3. The system 10 recited in claim 2 wherein the publishing element comprises a provider content software module 31 that allows a content provider to designate unique content types.

4. The system 10 recited in claim 1 wherein the publishing element comprises a provider content software module 31 that allows a content provider to manually and automatically submit content.

5. The system 10 recited in claim 1 wherein the publishing element comprises a provider content software module 31 that is configured to allow third party applications to be used to submit or publish data for broadcast.

6. The system 10 recited in claim 1 wherein the broadcasting element comprises a content distribution software engine 33 coupled to a data broadcast system 34.

7. The system 10 recited in claim 6 wherein the content distribution software engine 33 comprises means for scheduling broadcasts, scheduling unplanned broadcasts, scheduling premium/protected broadcasts, and global/free to air content broadcasts.

8. The system 10 recited in claim 6 wherein the content distribution software engine 33 tracks and logs transactions associated with each broadcast and outputs billing and usage information relating thereto.

9. The system 10 recited in claim 6 wherein the content distribution engine 33 enables conditional access by clients and content providers 11.

10. The system 10 recited in claim 6 wherein the content distribution engine 33 generates program schedules and relays the information to the data broadcast system 34 which broadcasts announcements of schedule in response thereto.

11. The system 10 recited in claim 6 further comprising a feed queue 32 for storing and forwarding packaged content.

12. The system 10 recited in claim 1 wherein the subscribing element 27 comprises a client software module 41 that allows manual and automatic, unattended, reception of packaged content, and real time acquisition of content streams based on announcement schedules.

13. The system 10 recited in claim 1 wherein the subscribing element 27 comprises a client software module 41 that manages data received from multiple content providers 11 within a singular data management scheme.

14. A method 60 for distributing data to remotely located personal computers 16, comprising the steps of:
packaging 61 data and data processing instructions for broadcast;
broadcasting 62 the data and data processing instructions;
receiving 63 the packaged data and data processing instructions at the remotely located personal computers 16; and
processing 64 the data at the remotely located personal computers in accordance with the data processing instructions.

15. The method 60 recited in claim 14 wherein the data processing instructions include scheduling instruction relating to content feeds and ad-hoc feeds.

16. The method 60 recited in claim 14 wherein the data processing instructions include scheduling instruction relating to designation of unique content types.

17. The method 60 recited in claim 14 wherein the data processing instructions include scheduling instruction relating to manual and automatic content submission.

18. The method 60 recited in claim 14 wherein the broadcasting step 62 comprises means for scheduling broadcasts, scheduling unplanned broadcasts, scheduling premium/protected broadcasts, and global/free to air content broadcasts.

19. The method 60 recited in claim 14 wherein the data processing instructions enable conditional access by clients and content providers 11.

20. The method 60 recited in claim 14 wherein the data processing instructions enable manual and automatic, unattended, reception of packaged content during the processing step 64.
